(19) United States
(12) Patent Application Publication
(10) Pub. No.: US 2023/0106395 A1
(43) Pub. Date: Apr. 6, 2023

(54) HIGH PRESSURE DEPOLYMERIZATION OF HDPE AND PP

(71) Applicant: Basell Poliolefine Italia S.r.l., Milan (IT)

(72) Inventors: David L. Ramage, Friendswood, TX (US); Christopher D. Smith, Houston, TX (US); Xueyong Yang, Bellaire, TX (US); Daniel F. White, Houston, TX (US); Sandor Nagy, Seabrook, TX (US)

(73) Assignee: Basell Poliolefine Italia S.r.l., Milan (IT)

(21) Appl. No.: 17/954,534

(22) Filed: Sep. 28, 2022

Related U.S. Application Data
(60) Provisional application No. 63/250,997, filed on Sep. 30, 2021.

(51) Int. Cl. C10G 1/10; C10B 53/07; C08J 11/12

(52) U.S. Cl. CPC C10G 1/10; C10B 53/07; C08J 11/12; C08J 2323/06; C10G 2300/1003

(57) ABSTRACT

A method of depolymerizing polymeric material including the steps of: (a) feeding a polymeric material to a depolymerization reactor maintained at a temperature in the range of from 400° C. to 600° C. and operated under a pressure in the range of from 4 to 15 barg; and (b) depolymerizing at least a portion of the polymeric material thereby forming a first gaseous product and a first liquid product.

### PRIOR RELATED APPLICATIONS

This application claims the benefit of priority to U.S. Provisional Patent Application No. 63/250,997, filed on Sep. 30, 2021, which is incorporated herein by reference in its entirety.

### FEDERALLY SPONSORED RESEARCH STATEMENT

Not applicable.

### FIELD OF THE DISCLOSURE

The disclosure generally relates to a process for effectively depolymerizing polymeric material under pressure. More specifically, this disclosure relates to a process for depolymerizing polymeric material under elevated pressures and without the use of a catalyst. The polymeric materials to be depolymerized may include high density polyethylene and polypropylene.

### BACKGROUND OF THE DISCLOSURE

Depolymerization, followed by additional processing including hydrogenation and cracking, presents an attractive route to convert polymeric material back to the materials from which the polymeric material were formed. One issue with thermal depolymerization is that both polyethylene and polypropylene produce depolymerization liquids with significant amounts of high molecular weight hydrocarbons, which complicate further processing.

One way to reduce the molecular weight distribution of depolymerization liquids is to utilize a catalyst. However, suitable catalysts for plastic depolymerization are often expensive, which makes the recycling process less economically feasible. Further, many catalysts can be poisoned by the additives, pigments and contaminants found in most target waste polymeric material streams. Thus, there exists a need to reduce the amount of high molecular weight hydrocarbons in depolymerization liquids obtained from polymeric materials.

### SUMMARY OF THE DISCLOSURE

In general, the present disclosure provides a method of depolymerizing polymeric material including the steps of: (a) feeding a polymeric material to a depolymerization reactor maintained at a temperature in the range of from 400° C. to 600° C. and operated under a pressure in the range of from 4 to 15 barg (58-218 psig); and (b) depolymerizing at least a portion of the polymeric material thereby forming a first gaseous product and a first liquid product.

As used herein, the term “Cx” refers to hydrocarbons having a specific number of carbon atoms. For example, C2 refers to hydrocarbons having two (2) carbon atoms, and C8 refers to hydrocarbons having eight (8) carbon atoms, C9+ refers to hydrocarbons having nine or more (9+) carbon atoms, etc.

As used herein, the term “depolymerization” refers to the breaking down of a polymer into smaller units or its monomers.

As used herein, “simulated distillation” is a method used to determine the true boiling point distribution of crude oil and petroleum refining fractions by gas chromatography. It is used as an alternative to physical distillation that is time consuming and labor intensive.

The following abbreviations are used herein:

| ABBREVIATION | TERM |
|---|---|
| FBP | Final boiling point |
| HDPE | High density polyethylene |
| IBP | Initial boiling point |
| PP | polypropylene |

This summary is provided to introduce a selection of concepts that are further described below in the detailed description. However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is an illustration of an example system, according to an embodiment of the disclosure;

FIG. 2 provides a comparison of boiling point data from Example 1 and Example 2;

FIG. 3 provides a comparison of boiling point data from Example 3 and Example 41 and

FIG. 4 presents a hydrocarbon analysis comparing the resulting depolymerization liquids from polypropylene and high density polyethylene, according to an embodiment of this disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

The disclosure herein generally involves a system and methodology for depolymerization of polymeric material under elevated pressure. Depolymerization at elevated pressure may produce a depolymerization liquid containing reduced amounts of C9+ hydrocarbons as compared to a depolymerization liquid produced at a lower (e.g., ambient) pressure. The C9+ hydrocarbon content in the depolymerization liquid may be reduced by 5%, 8%, 10%, 12%, 15%, or more using the systems and methodologies of this disclosure compared to a similar system or methodology operated at lower pressure. Surprisingly, such reduction may be accomplished without the use of a catalyst.

As a consequence, the simulated distillation boiling point curves of depolymerization liquids produced according to this disclosure can be depressed with increasing pressure. For polypropylene, the average boiling point depression over the entire curve is −33° C., with the highest quartile boiling point showing an average −69° C. depression. For polyethylene, the average boiling point depression over the entire curve was −35° C., with the highest quartile boiling points showing an average −53° C. depression. Additional confirmation of the effect of increased pressure is seen in both specific gravity data and in a detailed hydrocarbon analysis by GC.

In general, the present disclosure provides a method of depolymerizing polymeric material including the steps of: (a) feeding a polymeric material to a depolymerization reactor maintained at a temperature in the range of from 400° C. to 600° C. and operated under a pressure in the range of from 4 to 15 barg (58-218 psig); and (b) depolymerizing at least a portion of the polymeric material thereby forming a first gaseous product and a first liquid product.

In some embodiments the first liquid product has a composition comprising: (i) from about 3.5 wt % to about 6.0 wt % C2-C4s; (ii) from about 6.5 wt % to about 10.0 wt % C5s; (iii) from about 11.7 wt % to about 15.0 wt % C6s; (iv) from about 5.0 wt % to about 16.0 wt % C7s; (v) from about 9.0 wt % to about 16.0 wt % C8s; and (vi) less than about 59.5 wt % C9+.

In some embodiments of the disclosure, the method of depolymerizing polymeric material additionally comprises the step of: (c) directing the first liquid product to a cracking unit wherein at least a portion of the liquid product is converted into one or more olefins. In some embodiments of the disclosure, the cracking unit is a steam cracker. In some embodiments of the disclosure, the cracking unit is a fluidized catalytic cracking unit. In some embodiments of the disclosure, the cracking unit is an olefins furnace.

In some embodiments of the disclosure, when the polymeric material comprises polypropylene the first liquid product has a composition comprising: (i) from about 3.0 wt % to about 4.5 wt % C2-C4s; (ii) from about 7.5 wt % to about 11.5 wt % C5s; (iii) from about 12.5 wt % to about 16.5 wt % C6s; (iv) from about 4.2 wt % to about 6.4 wt % C7s; (v) from about 9.0 wt % to about 13.0 wt % C8s; and (vi) less than about 57.5 wt % C9+.

In some embodiments of the disclosure, the polymeric materials comprises at least 60 wt % polypropylene. In some embodiments of the disclosure, the polymeric materials comprises at least 65 wt % polypropylene. In some embodiments of the disclosure, the polymeric materials comprises at least 70 wt % polypropylene. In some embodiments of the disclosure, the polymeric materials comprises at least 75 wt % polypropylene. In some embodiments of the disclosure, the polymeric materials comprises at least 80 wt % polypropylene. In some embodiments of the disclosure, the polymeric material comprises at least 85 wt % polypropylene. In some embodiments of the disclosure, the polymeric materials comprises at least 90 wt % polypropylene. In some embodiments of the disclosure, the polymeric material comprises at least 95 wt % polypropylene. In some embodiments of the disclosure, the polymeric material comprises at least 98 wt % polypropylene.

In some embodiments of the disclosure, when the polymeric material comprises high density polyethylene the first liquid product has a composition comprising: (i) from about 4.5 wt % to about 6.5 wt % C2-C4s; (ii) from about 5.5 wt % to about 9.5 wt % C5s; (iii) from about 11.5 wt % to about 15.5 wt % C6s; (iv) from about 12.0 wt % to about 17.5 wt % C7s; (v) from about 12.0 wt % to about 17.5 wt % C8s; and (vi) less than about 50.0 wt % C9+.

In some embodiments of the disclosure, the polymeric materials comprises at least 60 wt % high density polyethylene. In some embodiments of the disclosure, the polymeric materials comprises at least 65 wt % high density polyethylene. In some embodiments of the disclosure, the polymeric materials comprises at least 70 wt % high density polyethylene. In some embodiments of the disclosure, the polymeric materials comprises at least 75 wt % high density polyethylene. In some embodiments of the disclosure, the polymeric materials comprises at least 80 wt % high density polyethylene. In some embodiments of the disclosure, the polymeric material comprises at least 85 wt % high density polyethylene. In some embodiments of the disclosure, the polymeric materials comprises at least 90 wt % high density polyethylene. In some embodiments of the disclosure, the polymeric material comprises at least 95 wt % high density polyethylene. In some embodiments of the disclosure, the polymeric material comprises at least 98 wt % high density polyethylene.

In some embodiments of the disclosure, depolymerization is conducted in the absence of a catalyst. In some embodiments of the disclosure, depolymerization is conducted in the absence of molecular oxygen. In some embodiments of the disclosure, depolymerization is conducted in the absence of both a catalyst and molecular oxygen. In some embodiments of the disclosure, depolymerization is conducted in an inert atmosphere.

In some embodiments of the disclosure, the reactor is operated at a temperature in the range of from 400° C. to 500° C. In some embodiments of the disclosure, the reactor is operated at a temperature in the range of from 400° C. to 450° C. In some embodiments of the disclosure, the reactor is operated at a temperature in the range of from 425° C. to 475° C. In some embodiments of the disclosure, the reactor is operated at a temperature in the range of from 425° C. to 525° C. In some embodiments of the disclosure, the reactor is operated at a temperature in the range of from 450° C. to 500° C. In some embodiments of the disclosure, the reactor is operated at a temperature in the range of from 450° C. to 550° C. In some embodiments of the disclosure, the reactor is operated at a temperature in the range of from 475° C. to 525° C. In some embodiments of the disclosure, the reactor is operated at a temperature in the range of from 475° C. to 575° C. In some embodiments of the disclosure, the reactor is operated at a temperature in the range of from 500° C. to 600° C. In some embodiments of the disclosure, the reactor is operated at a temperature in the range of from 500° C. to 550° C. In some embodiments of the disclosure, the reactor is operated at a temperature in the range of from 525° C. to 575° C. In some embodiments of the disclosure, the reactor is operated at a temperature in the range of from 550° C. to 600° C.

In some embodiments of the disclosure, the reactor is operated under a pressure in the range of from 4 to 8 barg. In some embodiments of the disclosure, the reactor is operated under a pressure in the range of from 4 to 12 barg. In some embodiments of the disclosure, the reactor is operated under a pressure in the range of from 4 to 14 barg. In some embodiments of the disclosure, the reactor is operated under a pressure in the range of from 6 to 10 barg. In some embodiments of the disclosure, the reactor is operated under a pressure in the range of from 6 to 12 barg. In some embodiments of the disclosure, the reactor is operated under a pressure in the range of from 6 to 15 barg. In some embodiments of the disclosure, the reactor is operated under a pressure in the range of from 8 to 15 barg. In some embodiments of the disclosure, the reactor is operated under a pressure in the range of from 8 to 12 barg. In some embodiments of the disclosure, the reactor is operated under a pressure in the range of from 8 to 10 barg. In some embodiments of the disclosure, the reactor is operated under a pressure in the range of from 10 to 15 barg. In some embodiments of the disclosure, the reactor is operated under a pressure in the range of from 10 to 15 barg. In some embodiments of the disclosure, the reactor is operated under a pressure in the range of from 12 to 15 barg. In some embodiments of the disclosure, the reactor is operated under a pressure in the range of from 12 to 14 barg.

In some embodiments of the disclosure, at least a portion of the polymeric material is post-industrial waste polymeric material. In some embodiments of the disclosure, the polymeric material is post-industrial waste polymeric material. In some embodiments of the disclosure, at least a portion of the polymeric material is post-consumer waste polymeric material. In some embodiments of the disclosure, the polymeric material is post-consumer waste polymeric material.

In some embodiments of the disclosure, the polymeric material is washed before being fed to the depolymerization reactor. In some embodiments of the disclosure, the polymeric material is washed with water before being fed to the depolymerization reactor.

In some embodiments of the disclosure, the polymeric material is a mixture of two or more polymeric materials. In some embodiments of the disclosure, the polymeric material may comprise: polyethylene, polypropylene, high density polyethylene, low density polyethylene, linear low density polyethylene. and ultra-high density polyethylene.

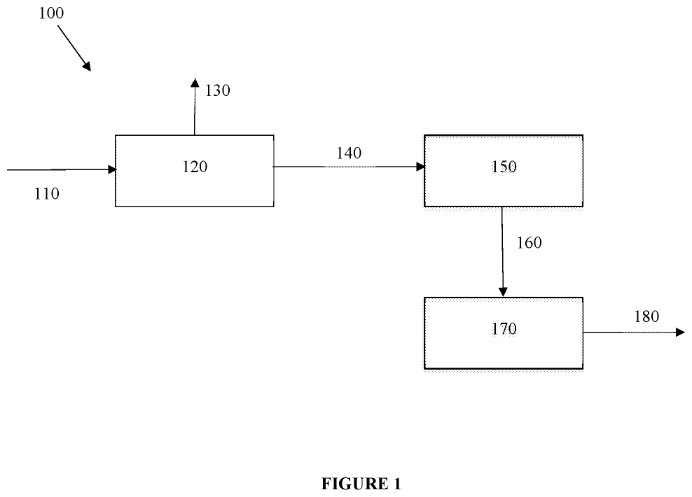

FIG. 1 provides an illustration of a system 100 according to an embodiment of the disclosure. A feed of polymeric material 110 is fed to depolymerization reactor 120. The polymeric material 110 is depolymerized within depolymerization reactor 120 under elevated pressure and without the use of a catalyst to form a gaseous product 130 and a liquid product 140. The gaseous product 130 may be vented from depolymerization reactor 120 and sent to a collection unit (not shown) or incorporated into another chemical process (also not shown). The liquid product 140 is collected from depolymerization reactor 130 and may be optionally sent to one or more treatment units 150. Treatment unit 150 may involve one or more processes (e.g., purification, filtration, chemical reaction, physical separations, etc.) that act on liquid product 140 to produce a treated liquid 160. Liquid product 140, or treated liquid 160 if the optional treatment unit is used, may be directed to cracking unit 170 wherein the liquid product 140 (or treated liquid 160 as the case may be) is at least partially converted into one or more olefins 180.

The following examples merely illustrate the systems and methodologies of this disclosure. Those skilled in the art will recognize many variations that are within the spirit of this disclosure and the scope of the claims.

### EXAMPLES 1-4

Depolymerization of polymeric materials were performed in a 1.8 L Hastelloy C276 reactor, equipped with an agitator and heated by a furnace. The polymeric materials were added to the reactor and sealed inside. A nitrogen gas (N₂) purge was established through the reactor and downstream equipment that comprises a heated overhead line and two product collection vessels maintained at ambient temperature. The overhead line comprised a vertical section maintained at 150° C., and a downward sloping line maintained at 100° C., which fed the product collection vessels. The pressure of the reactor was controlled by a back pressure regulator.

The furnace was set at 500° C. and then heating of the reactor was initiated. Once the furnace temperature reached 200° C., the N₂ purge was reduced to 50 standard cubic centimeter per minute (sccm). Upon the internal temperature reaching 200° C., the agitator was started at 60 rpm. The internal temperature was monitored until an inflection point in the time-dependent temperature curve was noted, which signified the onset of depolymerization. As soon as the inflection point was noted, the reaction was allowed to continue for three more hours. The reactor was then cooled, and the liquid product was collected and weighed. The reactor was opened and any solids removed and weighed. Gas yields were calculated by difference.

The polymeric material being depolymerized were LyondellBasell products HP522 (PP) and Hostalen ACP 9255 Plus (HDPE).

### Calculation

Liquid product samples were characterized by gas chromatography using an Agilent 7890 equipped with a non-polar column and FID. Typically, GC data used for liquid characterization can be sorted by their carbon atom numbers.

Additionally, simulated distillation was used to characterize the liquid products. The simulated distillation data for the liquid samples were collected using ASTM D7213 on an Agilent 6980. Simulated distillation data used for liquid characterization provides a boiling range distribution of light and medium petroleum distillate fractions, which can provide an insight into the composition of feedstocks and products.

Example 1 depolymerized HP522 PP at a pressure of 30 psig, whereas Example 2 depolymerized HP522 PP at a pressure of 90 psig. Example 3 depolymerized Hostalen ACP 9255 Plus at a pressure of 30 psig, whereas Example 4 depolymerized the same plastic at 90 psig. The results are shown in Table 1 and FIGS. 1-3.

TABLE 1
Depolymerization Conditions and Mass Balance

| | | | Depoly | | | Liquid | Gas | Liquid | | Gas + |
|---|---|---|---|---|---|---|---|---|---|---|
| | | Rx P | Onset T | Liquid | Residue | in RX | Yield by | Yield | Gas Yield | Liquid |
| Example | Polymer | (psig) | (° C.) | Yield (g) | (g) | (g) | MB (g) | (%) | (%) | Yield (%) |
| 1 | HP522 PP | 30 | 422 | 268 | 1 | 0 | 31 | 89 | 10 | 99.7 |
| 2 | HP522 PP | 90 | 423 | 258 | 1 | 0 | 41 | 86 | 14 | 99.7 |
| 3 | Host. ACP 9255 Plus | 30 | 453 | 241 | 1 | 0 | 58 | 80 | 19 | 99.7 |
| 4 | Host. ACP 9255 Plus | 90 | 458 | 229 | 1 | 8 | 63 | 76 | 21 | 97.0 |

Run Conditions: Polymer Mass = 300 g; Reactor Furnace T = 500° C.; N2 Flow Rate = 50 sccm; Batch Run Time = 180 min

As can be seen in Table 1, the depolymerization onset temperatures for Examples 1-2 (PP) and 3-4 (HDPE) are comparable. The liquid yield of Example 2 (86%) at elevated pressure is slightly lower than that of Example 1 (89%). Similar result can be found between Example 4 of higher pressure (76%) and Example 3 (80%). This indicates that under elevated pressure depolymerization favors the production of lower molecular weight products, as corroborated by the increased gas yield in Examples 2 & 4 (14%, 21%) comparing to Examples 1 & 3 (10%, 19%).

Table 2 provides specific gravity and simulated distillation data for Examples 1 through 4. As can be seen, all boiling points in Table 2 are lower at 90 psig comparing to 30 psig, except for the IBP (initial boiling point). The specific gravity for both polymers at 90 psig are also lower comparing to 30 psig. Specific gravity is a measure of chain length of a polymer, and lower specific gravity indicates shorter average chain length. Therefore, it is shown that elevating pressure of the depolymerization reactor effectively reduces the chain length.

TABLE 2
Specific Gravity and Simulated Distillation

| | | | Gravity, API | | | | | | | |
|---|---|---|---|---|---|---|---|---|---|---|
| | | Rx P | @ 60° F. | IBP | 10% | 30% | 50% | 70% | 90% | FBP |
| Example | Polymer | (psig) | (kg/m3) | (° C.) | (° C.) | (° C.) | (° C.) | (° C.) | (° C.) | (° C.) |
| 1 | HP522 PP | 30 | 744.2 | 22 | 64 | 136 | 138 | 202 | 307 | 532 |
| 2 | HP522 PP | 90 | 726.5 | 24 | 56 | 115 | 136 | 152 | 236 | 469 |
| 3 | Host. ACP 9255 Plus | 30 | 746.8 | 24 | 68 | 125 | 171 | 213 | 268 | 379 |
| 4 | Host. ACP 9255 Plus | 90 | | 23 | 56 | 100 | 132 | 173 | 218 | 327 |

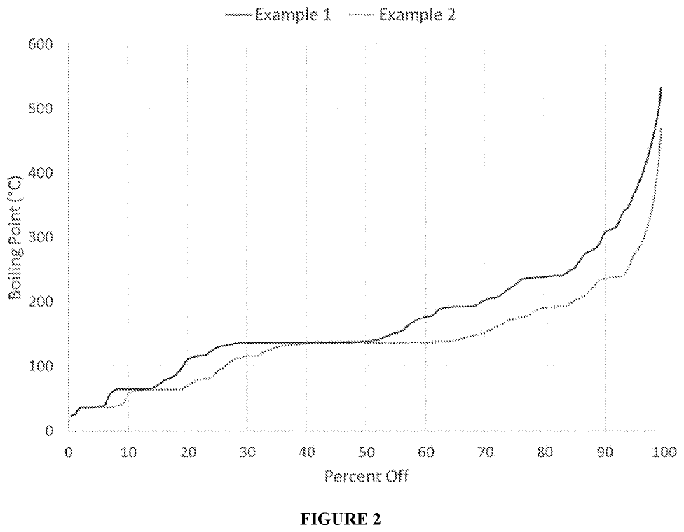

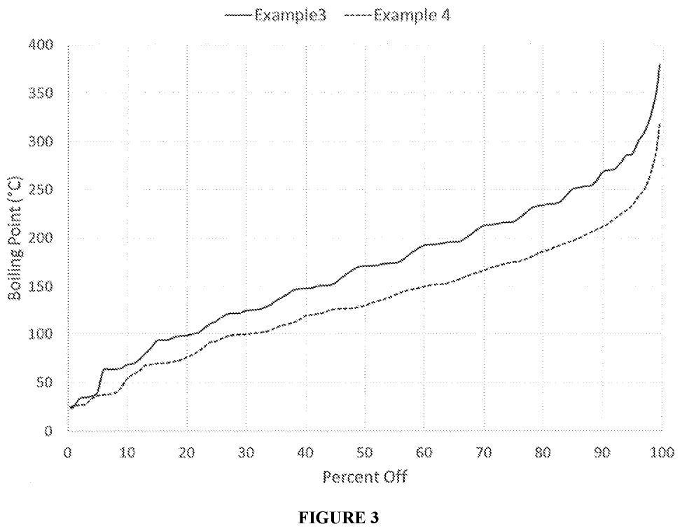

FIG. 2 presents the simulated distillation data for the polypropylene in Examples 1 and 2, while FIG. 3 provides the simulated distillation data for HDPE in Examples 3 and 4. The numerical results are provided in Table 3.

As can be seen in FIG. 2, the boiling points of Example 2 (dotted line) are lower than that of Example 1 (solid line) throughout the entire process. Similarly in FIG. 3, the boiling points of Example 4 (dotted line) are lower than that of Example 3 (solid line) throughout the entire process. Lower boiling points means less energy is required to heat the reactor to effectively carry out the depolymerization reaction, and if maintained at the same temperature, depolymerization can be more complete to yield shorter chain products that are more suitable for further processing.

TABLE 3
Full Simulated Distillation data

| | Example | Example | Example | Example |
|---|---|---|---|---|
| | 1 | 2 | 3 | 4 |
| Percent | PP | PP | HDPE | HDPE |
| Off | 30 psig | 90 psig | 30 psig | 90 psig |
| 0.5 | 22 | 24 | 24 | 24 |
| 1 | 25 | 24 | 25 | 26 |
| 2 | 36 | 34 | 33 | 26 |
| 3 | 36 | 35 | 35 | 27 |
| 4 | 37 | 35 | 36 | 33 |
| 5 | 37 | 36 | 40 | 36 |
| 6 | 39 | 36 | [symbol] 3 | 37 |
| 7 | 57 | 37 | 63 | 38 |
| 8 | 63 | 38 | 64 | 39 |
| 9 | 64 | 41 | 65 | 44 |
| 10 | 64 | 56 | 6 [symbol] | 54 |
| 11 | 64 | 62 | 69 | 58 |
| 12 | 64 | 62 | 73 | 61 |
| 13 | 65 | 63 | 79 | 67 |
| 14 | 65 | 63 | 85 | 68 |
| 15 | 71 | 63 | 93 | 69 |
| 16 | 77 | 63 | 94 | 70 |
| 17 | 81 | 63 | 94 | 70 |
| 18 | 87 | 64 | 97 | 71 |
| 19 | 98 | 64 | 98 | 73 |
| 20 | 111 | 70 | 98 | 76 |
| 21 | 114 | 75 | 100 | 78 |
| 22 | 116 | 79 | 101 | 82 |
| 23 | 117 | 80 | 106 | 8 [symbol] |
| 24 | 124 | 82 | 111 | 91 |
| 25 | 129 | 92 | 113 | 92 |
| 26 | 131 | 97 | 11 [symbol] | 9 [symbol] |
| 27 | 132 | 10 [symbol] | 122 | 98 |
| 28 | 135 | 111 | 122 | 99 |
| 29 | 135 | 113 | 123 | 99 |
| 30 | 136 | 115 | 125 | 99 |
| 31 | 136 | 116 | 12 [symbol] | 100 |
| 32 | 136 | 116 | 126 | 101 |
| 33 | 136 | 123 | 128 | 102 |
| 34 | 136 | 126 | 131 | 103 |
| 35 | 136 | 129 | 135 | 106 |
| 36 | 136 | 131 | 139 | 108 |
| 37 | 136 | 131 | 142 | 110 |
| 38 | 136 | 133 | 14 [symbol] | 111 |
| 39 | 136 | 135 | 14 [symbol] | 115 |
| 40 | 136 | 135 | 148 | 119 |
| 41 | 136 | 13 [symbol] | 148 | 120 |
| 42 | 136 | 13 [symbol] | 150 | 121 |
| 43 | 136 | 13 [symbol] | 151 | 122 |
| 44 | 136 | 13 [symbol] | 151 | 125 |
| 45 | 137 | 13 [symbol] | 154 | 126 |
| 46 | 137 | 13 [symbol] | 159 | 127 |
| 47 | 137 | 13 [symbol] | 163 | 127 |
| 48 | 137 | 136 | 167 | 127 |
| 49 | 137 | 136 | 170 | 129 |
| 50 | 138 | 136 | 171 | 130 |
| 52 | 141 | 136 | 172 | 134 |
| 53 | 144 | 136 | 173 | 136 |
| 54 | 149 | 136 | 174 | 138 |
| 55 | 151 | 136 | 174 | 141 |
| 56 | 154 | 136 | 176 | 143 |
| 57 | 162 | 136 | 181 | 145 |
| 58 | 169 | 136 | 185 | 147 |
| 59 | 173 | 136 | 190 | 148 |
| 60 | 176 | 136 | 193 | 149 |
| 61 | 178 | 137 | 193 | 151 |
| 62 | 186 | 137 | 194 | 152 |
| 63 | 190 | 137 | 194 | 152 |
| 64 | 191 | 138 | 196 | 153 |
| 65 | 192 | 139 | 196 | 155 |
| 66 | 192 | 141 | 197 | 157 |
| 67 | 192 | 144 | 200 | 160 |
| 68 | 193 | 148 | 205 | 162 |
| 69 | 197 | 149 | 209 | 164 |
| 70 | 202 | 152 | 213 | 166 |
| 71 | 206 | 156 | 214 | 169 |
| 72 | 207 | 161 | 214 | 170 |
| 73 | 212 | 165 | 216 | 172 |
| 74 | 220 | 171 | 216 | 174 |
| 75 | 22 [symbol] | 173 | 217 | 175 |
| 76 | 234 | 176 | 221 | 176 |
| 77 | 236 | 177 | 226 | 178 |
| 78 | 237 | 183 | 231 | 180 |
| 79 | 237 | 188 | 233 | 183 |
| 80 | 238 | 191 | 234 | 186 |
| 81 | 239 | 191 | 235 | 187 |
| 82 | 240 | 191 | 235 | 190 |
| 83 | 240 | 192 | 238 | 192 |
| 84 | 247 | 195 | 244 | 195 |
| 85 | 252 | 202 | 251 | 197 |
| 86 | 266 | 205 | 252 | 199 |
| 87 | 275 | 211 | 253 | 202 |
| 88 | 280 | 222 | 254 | 206 |
| 89 | 288 | 233 | 259 | 208 |
| 90 | 307 | 236 | 268 | 211 |
| 91 | 312 | 237 | 270 | 214 |
| 92 | 317 | 239 | 271 | 219 |
| 93 | 337 | 240 | 278 | 224 |
| 94 | 348 | 253 | 286 | 228 |
| 95 | 369 | 274 | 288 | 233 |
| 96 | 391 | 2 [symbol] 7 | 301 | 243 |
| 97 | 417 | 312 | 310 | 250 |
| 98 | 4 [symbol] 1 | 346 | 326 | 266 |
| 99 | 4 [symbol] 4 | 411 | 352 | 291 |
| 99. [symbol] | 532 | 469 | 379 | 318 |

[symbol]

indicates data missing or illegible when filed

Additionally, average boiling point depressions for polypropylene were calculated by subtracting the boiling point at 30 psig from the boiling point at 90 psig at every point along the simulated distillation curves for Examples 1 and 2 and averaging them for the entire curve, as well as for the four quartiles (Table 4). The same process was carried out for high density polyethylene and the average boiling point depression is also shown in Table 4.

TABLE 4
Average depression in Boiling Points by increasing pressure in different
portions of the stimulated distillation curves for PP and HDPE

| | Average Depression in Boiling Point (° C.) | | | | |
|---|---|---|---|---|---|
| | IBP to FBP | IBP-25% | 26-50% | 51-75% | 76%-FBP |
| PP | −33 | −16 | −9 | −39 | −69 |
| HDPE | −35 | −17 | −30 | −41 | −53 |

For polypropylene, the average boiling point depression over the entire curve was −33° C., with the highest quartile boiling points showing an average −69° C. depression. For high density polyethylene, the average boiling point depression over the entire curve was −35° C., with the highest quartile boiling points showing an average −53° C. depression.

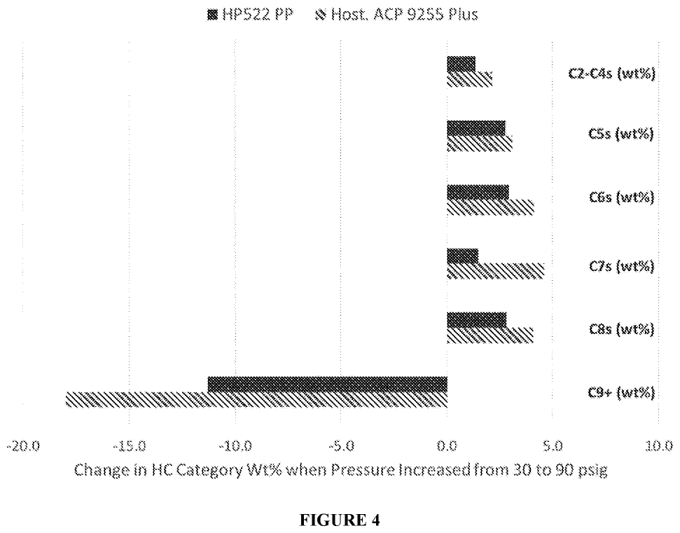

Detailed hydrocarbon analysis was carried out on the depolymerization liquids, and the summary data is shown in Table 5. FIG. 4 shows the visualization of distribution of different hydrocarbons.

TABLE 5
Detailed Hydrocarbon Analysis

| | | Rx P | C2-C4s | C5s | C6s | C7s | C8s | C9+ |
|---|---|---|---|---|---|---|---|---|
| Example | Polymer | (psig) | (wt %) | (wt %) | (wt %) | (wt %) | (wt %) | (wt %) |
| 1 | HP522 PP | 30 | 2.5 | 6.5 | 11.7 | 3.8 | 8.2 | 67.2 |
| 2 | HP522 PP | 90 | 3.8 | 9.3 | 14.6 | 5.3 | 11.0 | 55.9 |
| 3 | Host. ACP 9255 Plus | 30 | 3.5 | 4.6 | 9.1 | 10.9 | 11.6 | 60.2 |
| 4 | Host. ACP 9255 Plus | 90 | 5.7 | 7.7 | 13.2 | 15.5 | 15.7 | 42.2 |

As can be seen, the yield of preferred short-chain hydrocarbons (C2-C8) increases across the board. Specifically, for high density polyethylene, the largest increase occurred with C7s (˜4.5 wt % increase); while for PP, the largest increase occurred with C6s and C8s, at ˜3 wt % increase respectively.

The unwanted C9+ are also reduced significantly. For polyethylene, the yield of C9+ hydrocarbons is reduced by about 12 wt %. For high density polyethylene, the yield of C9+ hydrocarbons is reduced by almost 18 wt %. This again shows that the elevated pressure of 90 psig at depolymerization plays an important role in reducing the boiling point while improving the hydrocarbon distribution.

Thus, the present disclosure provides a novel process of molecularly recycling plastic wastes, particularly regarding polypropylene and polyethylene. By elevating the pressure inside the depolymerization reactor, the boiling points of the depolymerization liquid produced from polypropylene and high density polyethylene were each significantly reduced. With the reduced boiling point, the cost of depolymerization can also be reduced due to the lower reaction temperature. Moreover, the reduction in boiling points also means more complete depolymerization to produce fewer long-chain C9+ hydrocarbons.

### Additional Disclosure

Embodiments disclosed herein include:

A: a method of depolymerizing polymeric material comprising the steps of: (a) feeding a polymeric material to a depolymerization reactor maintained at a temperature in the range of from 400° C. to 600° C. and operated under a pressure in the range of from 4 to 15 barg (58-218 psig); and (b) depolymerizing at least a portion of the polymeric material thereby forming a first gaseous product and a first liquid product.

Embodiment A may have one or more of the following additional elements:

Element 1: the first liquid product has a composition comprising: (i) from about 3.5 wt % to about 6.0 wt % C2-C4s; (ii) from about 6.5 wt % to about 10.0 wt % C5s; (iii) from about 11.7 wt % to about 15.0 wt % C6s; (iv) from about 5.0 wt % to about 16.0 wt % C7s; (v) from about 9.0 wt % to about 16.0 wt % C8s; and (vi) less than about 59.5 wt % C9+.

Element 2: additionally comprises the step of: (c) directing the first liquid product to a cracking unit wherein at least a portion of the liquid product is converted into one or more olefins.

Element 3: when the polymeric material comprises polypropylene the first liquid product has a composition comprising: (i) from about 3.0 wt % to about 4.5 wt % C2-C4s; (ii) from about 7.5 wt % to about 11.5 wt % C5s; (iii) from about 12.5 wt % to about 16.5 wt % C6s; (iv) from about 4.2 wt % to about 6.4 wt % C7s; (v) from about 9.0 wt % to about 13.0 wt % C8s; and (vi) less than about 57.5 wt % C9+.

Element 4: the polymeric materials comprises at least 60 wt % polypropylene. In some embodiments of the disclosure, the polymeric materials comprises at least 65 wt % polypropylene. Element 5: the polymeric materials comprises at least 70 wt % polypropylene. Element 6: the polymeric materials comprises at least 75 wt % polypropylene. Element 7: the polymeric materials comprises at least 80 wt % polypropylene. Element 8: the polymeric material comprises at least 85 wt % polypropylene. Element 9: the polymeric materials comprises at least 90 wt % polypropylene. Element 10: the polymeric material comprises at least 95 wt % polypropylene. Element 11: the polymeric material comprises at least 98 wt % polypropylene.

Element 12: when the polymeric material comprises high density polyethylene the first liquid product has a composition comprising: (i) from about 4.5 wt % to about 6.5 wt % C2-C4s; (ii) from about 5.5 wt % to about 9.5 wt % C5s; (iii) from about 11.5 wt % to about 15.5 wt % C6s; (iv) from about 12.0 wt % to about 17.5 wt % C7s; (v) from about 12.0 wt % to about 17.5 wt % C8s; and (vi) less than about 50.0 wt % C9+.

Element 13: the polymeric materials comprises at least 60 wt % high density polyethylene. Element 14: the polymeric materials comprises at least 65 wt % high density polyethylene. Element 15: the polymeric materials comprises at least 70 wt % high density polyethylene. Element 16: the polymeric materials comprises at least 75 wt % high density polyethylene. Element 17: the polymeric materials comprises at least 80 wt % high density polyethylene. Element 18: the polymeric material comprises at least 85 wt % high density polyethylene. Element 19: the polymeric materials comprises at least 90 wt % high density polyethylene. Element 20: the polymeric material comprises at least 95 wt % high density polyethylene. Element 21: the polymeric material comprises at least 98 wt % high density polyethylene.

Element 22: depolymerization is conducted in the absence of a catalyst. Element 23: depolymerization is conducted in the absence of molecular oxygen. Element 24: depolymerization is conducted in the absence of both a catalyst and molecular oxygen. Element 25: depolymerization is conducted in an inert atmosphere.

Element 26: the reactor is operated at a temperature in the range of from 400° C. to 500° C. Element 27: the reactor is operated at a temperature in the range of from 400° C. to 450° C. Element 28: the reactor is operated at a temperature in the range of from 425° C. to 475° C. Element 29: the reactor is operated at a temperature in the range of from 425° C. to 525° C. Element 30: the reactor is operated at a temperature in the range of from 450° C. to 500° C. Element 31: the reactor is operated at a temperature in the range of from 450° C. to 550° C. Element 32: the reactor is operated at a temperature in the range of from 475° C. to 525° C. Element 33: the reactor is operated at a temperature in the range of from 475° C. to 575° C. Element 34: the reactor is operated at a temperature in the range of from 500° C. to 600° C. Element 35: the reactor is operated at a temperature in the range of from 500° C. to 550° C. Element 36: the reactor is operated at a temperature in the range of from 525° C. to 575° C. Element 37: the reactor is operated at a temperature in the range of from 550° C. to 600° C.

Element 38: the reactor is operated under a pressure in the range of from 4 to 8 barg. Element 39: the reactor is operated under a pressure in the range of from 4 to 12 barg. Element 40: the reactor is operated under a pressure in the range of from 4 to 14 barg. Element 41: the reactor is operated under a pressure in the range of from 6 to 10 barg. Element 42: the reactor is operated under a pressure in the range of from 6 to 12 barg. Element 43: the reactor is operated under a pressure in the range of from 6 to 15 barg. Element 44: the reactor is operated under a pressure in the range of from 8 to 15 barg. Element 45: the reactor is operated under a pressure in the range of from 8 to 12 barg. Element 46: the reactor is operated under a pressure in the range of from 8 to 10 barg. Element 47: the reactor is operated under a pressure in the range of from 10 to 15 barg. Element 48: the reactor is operated under a pressure in the range of from 10 to 15 barg. Element 49: the reactor is operated under a pressure in the range of from 12 to 15 barg. Element 50: the reactor is operated under a pressure in the range of from 12 to 14 barg.

Element 51: at least a portion of the polymeric material is post-industrial waste polymeric material. Element 52: the polymeric material is post-industrial waste polymeric material. Element 53: at least a portion of the polymeric material is post-consumer waste polymeric material. Element 54: the polymeric material is post-consumer waste polymeric material.

Element 55: the polymeric material is washed before being fed to the depolymerization reactor. Element 56: the polymeric material is washed with water before being fed to the depolymerization reactor.

Element 57: the polymeric material is a mixture of two or more polymeric materials. Element 58: the polymeric material may comprise: polyethylene, polypropylene, high density polyethylene, low density polyethylene, linear low density polyethylene. and ultra-high density polyethylene.

Element 59: wherein the cracking unit is a steam cracker. Element 60: wherein the cracking unit is a fluidized catalytic cracking unit. Element 61: wherein the cracking unit is an olefins furnace.

The particular embodiments disclosed above are merely illustrative, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and such variations are considered within the scope and spirit of the present disclosure. Alternative embodiments that result from combining, integrating, and/or omitting features of the embodiment(s) are also within the scope of the disclosure. While compositions and methods are described in broader terms of “having”, “comprising,” “containing,” or “including” various components or steps, the compositions and methods can also “consist essentially of” or “consist of” the various components and steps. Use of the term “optionally” with respect to any element of a claim means that the element is present, or alternatively, the element is not present, both alternatives being within the scope of the claim. In the claims, means-plus-function clauses are intended to cover the structures described herein as performing the recited function and not only structural equivalents, but also equivalent structures. It is the express intention of the applicant not to invoke 35 U. S.C. § 112, paragraph 6 for any limitations of any of the claims herein, except for those in which the claim expressly uses the words “means for” together with an associated function.

Numbers and ranges disclosed above may vary by some amount. Whenever a numerical range with a lower limit and an upper limit is disclosed, any number and any included range falling within the range is specifically disclosed. In particular, each range of values (of the form, “from about a to about b,” or, equivalently, “from approximately a to b,” or, equivalently, “from approximately a-b”) disclosed herein is to be understood to set forth each number and range encompassed within the broader range of values. Also, the terms in the claims have their plain, ordinary meaning unless otherwise explicitly and unambiguously defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

Accordingly, the scope of protection is not limited by the description set out above but is only limited by the claims which follow, such scope including equivalents of the subject matter of the claims.

What is claimed is:

1. A method of depolymerizing polymeric material comprising the steps of:
(a) feeding a polymeric material to a depolymerization reactor maintained at a temperature in the range of from 400° C. to 600° C. and operated under a pressure in the range of from 4 to 15 barg (58-218 psig); and
(b) depolymerizing at least a portion of the polymeric material thereby forming a first gaseous product and a first liquid product, wherein the first liquid product has a composition comprising:
(i) from about 3.5 wt % to about 6.0 wt % C2-C4s;
(ii) from about 6.5 wt % to about 10.0 wt % C5s;
(iii) from about 11.7 wt % to about 15.0 wt % C6s;
(iv) from about 5.0 wt % to about 16.0 wt % C7s;
(v) from about 9.0 wt % to about 16.0 wt % C8s; and
(vi) less than about 59.5 wt % C9+.

2. The method of depolymerizing polymeric material of claim 1 additionally comprising the step of:
(c) directing the first liquid product to a steam cracker or fluidized catalytic cracking unit wherein at least a portion of the liquid product is converted into one or more olefins.

3. The method of depolymerizing polymeric material of claim 1 wherein when the polymeric material comprises polypropylene the first liquid product has a composition comprising:
(i) from about 3.0 wt % to about 4.5 wt % C2-C4s;
(ii) from about 7.5 wt % to about 11.5 wt % C5s;
(iii) from about 12.5 wt % to about 16.5 wt % C6s;
(iv) from about 4.2 wt % to about 6.4 wt % C7s;
(v) from about 9.0 wt % to about 13.0 wt % C8s; and
(vi) less than about 57.5 wt % C9+.

4. The method of depolymerizing polymeric material of claim 3 wherein the polymeric material comprises at least 85 wt % polypropylene.

5. The method of depolymerizing polymeric material of claim 1 wherein when the polymeric material comprises high density polyethylene the first liquid product has a composition comprising:
(i) from about 4.5 wt % to about 6.5 wt % C2-C4s;
(ii) from about 5.5 wt % to about 9.5 wt % C5s;
(iii) from about 11.5 wt % to about 15.5 wt % C6s;
(iv) from about 12.0 wt % to about 17.5 wt % C7s;
(v) from about 12.0 wt % to about 17.5 wt % C8s; and
(vi) less than about 50.0 wt % C9+.

6. The method of depolymerizing polymeric material of claim 5 wherein the polymeric material comprises at least 85 wt % high density polyethylene.

7. The method of depolymerizing polymeric material of claim 1 wherein depolymerization is conducted in the absence of a catalyst.

8. The method of depolymerizing polymeric material of claim 1 wherein depolymerization is conducted in the absence of molecular oxygen.

9. The method of depolymerizing polymeric material of claim 1 wherein depolymerization is conducted in an inert atmosphere.

10. The method of depolymerizing polymeric material of claim 1 wherein the reactor is operated at a temperature in the range of from 400° C. to 500° C.

11. The method of depolymerizing polymeric material of claim 1 wherein the reactor is operated at a temperature in the range of from 450° C. to 550° C.

12. The method of depolymerizing polymeric material of claim 1 wherein the reactor is operated at a temperature in the range of from 500° C. to 600° C.

13. The method of depolymerizing polymeric material of claim 1 wherein the reactor is operated under a pressure in the range of from 10 to 15 barg.

14. The method of depolymerizing polymeric material of claim 1 wherein the reactor is operated under a pressure in the range of from 6 to 12 barg.

15. The method of depolymerizing polymeric material of claim 1 wherein the reactor is operated under a pressure in the range of from 4 to 8 barg.

16. The method of depolymerizing polymeric material of claim 1 wherein the polymeric material is post-industrial waste polymeric material.

17. The method of depolymerizing polymeric material of claim 1 wherein the polymeric material is post-consumer waste polymeric material.

18. The method of depolymerizing polymeric material of claim 1 wherein the polymeric material is washed before being fed to the depolymerization reactor.

19. The method of depolymerizing polymeric material of claim 1 wherein the polymeric material is a mixture of two or more polymeric materials.
